(19) United States
(12) Patent Application Publication
(10) Pub. No.: US 2004/0128372 A1
(43) Pub. Date: Jul. 1, 2004

(54) Architecture for managing computer resources

(76) Inventors: Amit Mukherjee, Bangalore (IN); Anantha P. Rathnam, Chennai (IN); Lakshmi Ramachandran, Bangalore (IN); Chirayu Patel, Bangalore (IN); Santosh Balakrishnan, Beverly Hills, CA (US); Martin Frey, Los Angeles, CA (US); Akshay Kadam, Los Angeles, CA (US); Rishi Mukhopadhyay, Los Angeles, CA (US)

Correspondence Address: KENYON & KENYON, 1500 K STREET, N.W., SUITE 700, WASHINGTON, DC, 20005, US

(21) Appl. No.: 10/319,682

(22) Filed: Dec. 16, 2002

(51) Int. Cl. G06F 15/173

(52) U.S. Cl. 709/223

(57) ABSTRACT

A computer system management module includes a common object module. The management module further includes an object resource manager, an edge resource manager coupled, and a transaction manager coupled to the common object module. The management module further includes an alarm manager coupled to the object resource manager.

### FIELD OF THE INVENTION

One embodiment of the present invention is directed to computer systems. More particularly, one embodiment of the present invention is directed to an architecture for managing resources of computer systems.

### BACKGROUND INFORMATION

Any integrated computer system requires a method by which it can be managed by an external management entity. Management typically involves configuration and control of the different system components such as the operating system, application programs, various hardware components, etc. The management entity itself needs to be robust and available at all times. It should provide a cohesive picture of all the components of the system and the relation between the different components. Moreover, such a management architecture should be reusable and extensible so that it can be easily enhanced to handle different kind of systems.

Current management methods require intimate knowledge of each and every parameter in the computer system. The relation between the different components of the system is not adequately captured. Multiple alarms/indications are generated by different components of the system for the same event. Another intelligent entity (e.g., a human being) is required to correlate all these events and make a final conclusion. The management entity itself is not robust and may be unavailable at times. Most management architectures are not extensible and any enhancements/modifications in the system being managed requires re-architecting the management entity.

Based on the foregoing, there is a need for an improved architecture for managing components in a computer system.

### BRIEF DESCRIPTION OF THE DRAWINGS

FIG. 1 is a block diagram of a management module in accordance with one embodiment of the present invention

### DETAILED DESCRIPTION

One embodiment of the present invention is a management architecture (or “management module”) for managing components of a computer system in one embodiment, the components are part of a protocol stack of a telecommunication computer system. The management architecture uses the concept of resources to model the system being managed. Each resource is an entity which can be managed and controlled individually. Each resource is characterized by properties and operations. Properties provide a description of the resource (e.g., a link resource has a property called link speed). Resources usually include multiple properties.

Operations represent the dynamic part of a resource. Each operation describes what activity can be performed on a resource (e.g., a “CreateLink” operation creates a new link instance).

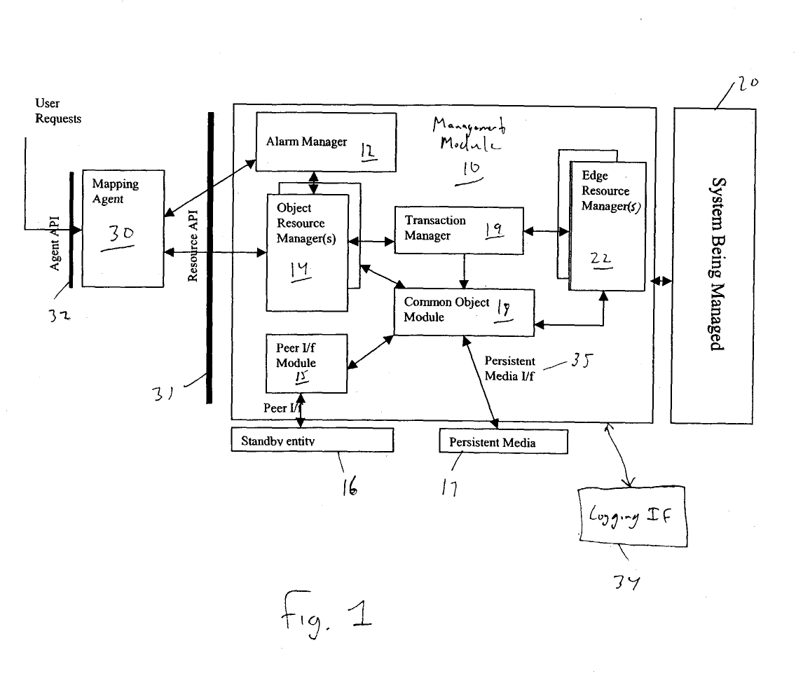

FIG. 1 is a block diagram of a management module 10 in accordance with one embodiment of the present invention. Management module 10 is coupled to a system 20 that is being managed.

Management module 10 includes object resource managers 14 and edge resource managers 22. In one embodiment, management module 10 includes a resource manager for each class of resource being managed (e.g., there can be a link resource manager for a Link resource). Each resource manager is responsible for managing the many instances of its class. Any operation on a resource needs to be validated by the respective resource manager. Both object resource managers 14 and edge resource managers 22 are resource managers only. Each edge resource manager interfaces with one protocol layer. Object resource managers 14 send the information to layers through edge resource managers 22 only.

Management module 10 is coupled to one or more mapping agents 30. Mapping agent 30 is the connection between the user of management module 10 and management module 10. The user interfaces with mapping agent 30 through an agent application program interface (“API”) 32. Mapping agent 30 translates agent API 32 requests to a form which the object resource managers 14 and an alarm manager 12 understand.

Management module 10 further includes the alarm manager 12 which is responsible for maintaining alarm information within management module 10 and reporting them to mapping agent 30 based on an alarm filtering criteria. To receive alarms, the mapping agents 30 register with alarm manager 12. The registration happens over resource API 31.

Management module 10 further includes a common object module 18. All data structures used to implement the resource model are stored in common object module 18. The choice of data structures is governed by the kind of operations that will be performed on the resources. Common object module 18 maintains information for each instance of a resource. To perform any operation, in one embodiment object resource managers 14 and edge resource managers 22 have access to common object module 18. Common object module 18 stores stable state information and allows for fault tolerance of active and standby management entities.

Management module 10 further includes a transaction manager 19 that implements inter-resource manager communication between object resource managers 14 and edge resource managers 22 through a publish subscribe mechanism. For example, one resource manager publishes an event (e.g., Link Create). Other resource managers would have subscribed for this event. The resource managers communicate with each other through transaction manager 19. All publishers and subscribers register with transaction manager 19.

A persistent media 17 is coupled to management module 10. Persistent media 17 is where persistent information is stored. The persistent information may be required across invocations of management module 10. Typically, persistent media 17 will be used to store resource configurations which can be accessed by management module 10. In one embodiment, persistent media 17 is a database stored on an external module such as a disk drive.

Management module 10 further includes a persistent media interface 35. Interaction with persistent media 17 takes place over this interface. Usually, resource specific configuration information is exchanged on this interface. Management module 10 does not depend on the nature of persistent media 17 because of persistent media interface 35.

Management module 10 further includes a peer interface module 15 that implements a peer update and warm start mechanism within management module 10. Whenever the database of common object module 18 changes (e.g., for operations like Create, Delete, Reconf, and Sync), common object module 18 invokes peer interface module 15 to send the update information to a standby management entity 16 that is coupled to management module 10. Standby entity 16 includes the same modules that are included in management module 10. Updates are done to standby entity 16 so that even if transactions were to fail before being completed, the system will not be in an inconsistent state.

Management module 10 further includes a logging interface 34 that is used to log alarms, traces and debug information. Most of the logging information will come from edge resource managers 22 which directly interact with layers.

The following is an example of a typical flow of information between the modules included in or coupled to management module 10.

1. Mapping agent 30 issues a request to object resource manager 14.

2. Object resource manager 14 requests transaction manager 19 to allocate a transaction context to process the request.

3. Object resource manager 14 interacts with common object module 18 to read or update the received information in common object module 18 and other object/edge resource managers.

4. Common object module 18 informs peer interface module 15 about the updates. Peer interface module 15 keeps the record of changes against the current transaction.

5. Object resource manager 14 publishes the requested event with the necessary information through transaction manager 19.

6. Object resource manager 14 sends a confirm back to mapping agent 30.

7. All the interested edge resource managers 22 receive the event.

8. Edge resource managers 22 collect the necessary information from transaction manager 19 and common object module 18.

9. Edge resource managers 22 send appropriate requests to the system 20 being managed.

10. Edge resource managers 22 collect the acknowledgement from the system 20 being managed and updates the information in common object module 18.

11. Edge resource managers 22 publish the acknowledgement event through transaction manager 19.

12. Object resource manager 14 receives the event and updates common object module 18.

13. Object resource manager 14 informs transaction manager 19 about the completion of the transaction.

14. Transaction manager 19 informs common object module 18 about the completion.

15. Common object module 18 updates the information in persistent media 17. In other embodiments, other modules, such as standby entity 16, may update persistent media 17.

16. Common object module 18 informs peer interface module 15 about the completion.

17. Peer interface module 15 sends the change record to standby entity 16.

18. The peer interface module in standby entity 16 receives the change record.

19. The peer interface module in standby entity 16 informs the common object module in standby entity 16.

20. The common object module in standby entity 16 updates the persistent media connected to standby entity 16. In other embodiments, other modules may update the persistent media.

21. Object resource manager 14 sends an indication to mapping agent 30 about the completion of the transaction. In some embodiments, the confirmation may be sent to mapping agent 30 even before the transaction is completed. In such cases, the actual completion is signaled through alarms.

As described, the management architecture in accordance with one embodiment of the present invention manages the components of a computer system by using the concept of resources to model the system being managed. The architecture allows common object module 18 and resource API 31 to be generated from a resource definition. This makes any feature addition relatively simple. Common object module 18 and transaction manager 19 together take care of persistent media 17 and standby entity 16. This allows object resource manager 14 and edge resource manager 22 to be designed without concern about data persistency and high availability.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A computer system management module comprising:
a common object module;
an object resource manager coupled to said common object module;
an edge resource manager coupled to said common object module;
a transaction manager coupled to said common object module; and
an alarm manager coupled to said object resource manager.

2. The computer system management module of claim 1, wherein said alarm manager is coupled to a mapping agent through a resource application program interface.

3. The computer system management module of claim 1, further comprising a peer interface module coupled to said common object module.

4. The computer system management module of claim 1, wherein said peer interface module is coupled to a standby entity.

5. The computer system management module of claim 1, further comprising a persistent media coupled to said common object module.

6. The computer system management module of claim 2, wherein an agent application program interface is coupled to said mapping agent.

7. A computer readable medium having instructions stored thereon that, when executed by a processor, implements a computer system management module comprising:
a common object module;
an object resource manager coupled to said common object module;
an edge resource manager coupled to said common object module;
a transaction manager coupled to said common object module; and
an alarm manager coupled to said object resource manager.

8. The computer readable medium of claim 7, wherein said alarm manager is coupled to a mapping agent through a resource application program interface.

9. The computer readable medium of claim 7, said computer system management module further comprising a peer interface module coupled to said common object module.

10. The computer readable medium of claim 7, wherein said peer interface module is coupled to a standby entity.

11. The computer readable medium of claim 7, said computer system management module further comprising a persistent media coupled to said common object module.

12. The computer readable medium of claim 8, wherein an agent application program interface is coupled to said mapping agent.

13. A method of managing a computer system comprising:
modeling a plurality of resources of the computer system in a common object module;
managing each class of the resources with a plurality of resource managers;
implementing inter-resource communication between the resource managers; and
maintaining alarm information based on an alarm filtering criteria.

14. The method of claim 13, wherein the resource managers comprise an edge resource manager and an object resource manager.

15. The method of claim 13, wherein the inter-resource communication is implemented with a publish subscribe mechanism.

16. The method of claim 13, further comprising:
connecting a user through a mapping agent.
